(19) United States
(12) Patent Application Publication
(10) Pub. No.: US 2016/0195872 A1
(43) Pub. Date: Jul. 7, 2016

(54) System for Assisting Operation at the Time of Plant Accident and Method for Assisting Operation at the Time of Plant Accident

(71) Applicant: Hitachi, Ltd., Tokyo (JP)

(72) Inventors: Setsuo ARITA, Tokyo (JP); Masaki KANADA, Tokyo (JP); Yoshihiko ISHII, Tokyo (JP); Ryota KAMOSHIDA, Tokyo (JP); Tadaaki ISHIKAWA, Tokyo (JP); Kenichi KATONO, Tokyo (JP)

(21) Appl. No.: 14/916,535

(22) PCT Filed: Sep. 11, 2013
(86) PCT No.: PCT/JP2013/074455

§ 371 Date: Mar. 3, 2016

(51) Int. Cl. G05B 23/02

(52) U.S. Cl. CPC G05B 23/0229

(57) ABSTRACT

An object of the invention is to provide a system for assisting operation at the time of a plant accident, which, even if a device malfunctions at the time of the plant accident, can determine normality of a sensor without being influenced by the malfunction. A system for assisting operation at the time of a plant accident, includes: a phenomenon identification apparatus for identifying a state of a plant; a plant behavior analysis apparatus for predicting progress of a process state after a phenomenon occurs by using at least a phenomenon identification result as an initial condition of plant behavior analysis; and a sensor normality determination apparatus for determining normality of a sensor by comparing a result of prediction of the progress of the process state which is output from the plant behavior analysis apparatus with a sensor signal.

### TECHNICAL FIELD

The present invention relates to a system for assisting operation at the time of a plant accident and a method for assisting operation at the time of a plant accident, each of which assists operation of a plant at the time of the accident by identifying a state of the plant including a sensor at the time of the plant accident.

### BACKGROUND ART

In the case where abnormality or an accident occurs in any of various plants such as a nuclear power plant, a thermal power plant, and a chemical plant, an operator needs to quickly grasp a state of the plant and perform appropriate dealing operation. [PTL 1] discloses a plant operation assisting apparatus that can automatically diagnose normality of various measuring instruments including a sensor in order to assist an operator in the case where abnormality or an accident occurs. Specifically, first, a device model obtained by quantitatively simulating a static characteristic of a plant component is stored in a characteristic storage unit, and an observation signal and the device model are input in a state estimation unit, and then a process state is estimated on the basis of the observation signal by using the device model. Finally, the normality of the sensor is evaluated on the basis of fuzzy inference by using a result obtained in the state estimation unit.

### CITATION LIST

### Patent Literature

PTL 1: JP-A-7-181292

### SUMMARY OF INVENTION

### Technical Problem(s)

In PTL 1, a plurality of device model formulae are provided, and an observation signal serving as a sensor signal is input to the device model formulae, and then output signals corresponding to input/output characteristics of the device model formulae are output, and, when any one of the plurality of output signals of the device models matches the observation signal (sensor signal) corresponding to the output signals of the device model formulae, the observation signal is determined to be normal. When a plant is abnormal, a device including piping malfunctions in many cases. A device model formula in which a malfunction state is reflected is not provided, and therefore, even in the case where output signals of the device model formulae are calculated in a device malfunction state on the basis of an observation signal (sensor signal) by using the device model formulae prepared in advance, a result thereof does not match an observation signal on an output side of the corresponding device. As a result, it is problematic in that an observation signal serving as an output signal of a sensor is determined to be abnormal, i.e., the sensor is determined to be abnormal. Even if the sensor is made redundant, the redundant sensors behave in the same way as the device in the case where behavior of the device influences the redundant sensors in common. Therefore, it is similarly problematic in that output signals (observation signals) of the redundant sensors are determined to be abnormal even in the case where the device malfunctions.

The invention has been made in view of the above points, and an object of the invention is to provide a system for assisting operation at the time of a plant accident, which, even if a device malfunctions at the time of the plant accident, can determine normality of a sensor without being influenced by the malfunction.

### Solution to Problem

The invention includes: a phenomenon identification apparatus for identifying a state of a plant; a plant behavior analysis apparatus for predicting progress of a process state after a phenomenon occurs by using at least a phenomenon identification result as an initial condition of plant behavior analysis; and a sensor normality determination apparatus for determining normality of a sensor by comparing a result of prediction of the progress of the process state which is output from the plant behavior analysis apparatus with a sensor signal.

### Advantageous Effects of Invention

According to the invention, it is possible to provide a system for assisting operation at the time of a plant accident, which, even if a device malfunctions at the time of the plant accident, can determine normality of a sensor without being influenced by the malfunction.

### BRIEF DESCRIPTION OF DRAWINGS

FIG. 1 is a configuration diagram of a system for assisting operation at the time of a plant accident according to Embodiment 1 of the invention.

FIG. 2 is an explanatory view of phenomenon identification.

FIG. 3 is an explanatory view of a plant behavior analysis model.

FIG. 4 is a diagram for explaining determination of abnormality of a pressure sensor.

FIG. 5 is a diagram for explaining determination of breakage of piping.

FIG. 6 is a configuration diagram of a system for assisting operation at the time of a plant accident according to Embodiment 2 of the invention.

FIG. 7 shows a state in which a time of a sensor signal and a time of a process state prediction result are not synchronized.

FIG. 8 is a diagram in which synchronization between a time of a sensor signal and a time of a process state prediction result is achieved.

FIG. 9 shows an example of output results from a plant behavior analysis apparatus 3, phenomenon identification apparatuses 4 and 4a, and sensor normality determination apparatuses 8 and 8a.

### DESCRIPTION OF EMBODIMENTS

Hereinafter, examples will be described.

### Example 1

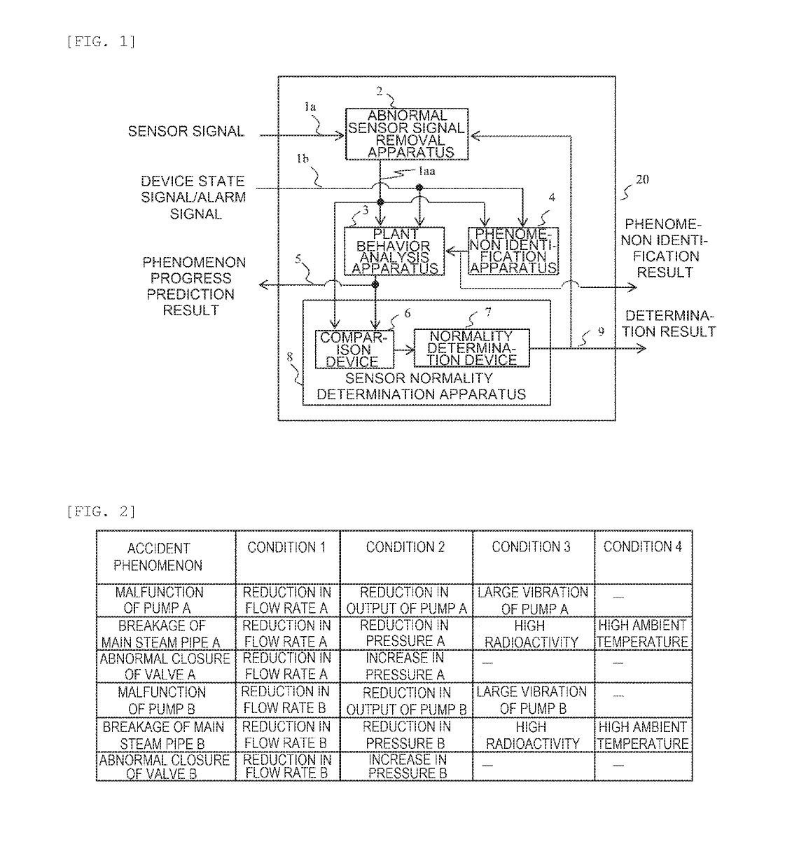

Hereinafter, this example will be described in detail with reference to drawings. FIG. 1 is a configuration diagram of a system for assisting operation at the time of a plant accident according to Embodiment 1, and the following description will be made by using a nuclear power plant as a representative.

A sensor signal 1a is a process signal of a temperature, a pressure, a water level, a flow rate, or the like in the plant, and 1b is a device state signal/alarm signal. Although not shown, those signals are generated by an alarm processing system, a control apparatus, and a process computer. Note that the device state signal is a state signal indicating start/stop, opening/closing, or the like of a pump, a valve, or the like which is a device of the plant. The sensor signal 1a is taken in by an abnormal sensor signal removal apparatus 2, and a sensor signal output as an abnormal signal is removed, whereas a normal sensor signal 1aa is taken in by a plant behavior analysis apparatus 3 and a phenomenon identification apparatus 4. In the case of redundant sensors, a signal of a sensor outputting an abnormal value is removed in the abnormal sensor signal removal apparatus 2 on the basis of majority rule determination of output signals of the redundant sensors. 20 is a system for assisting operation at the time of a plant accident.

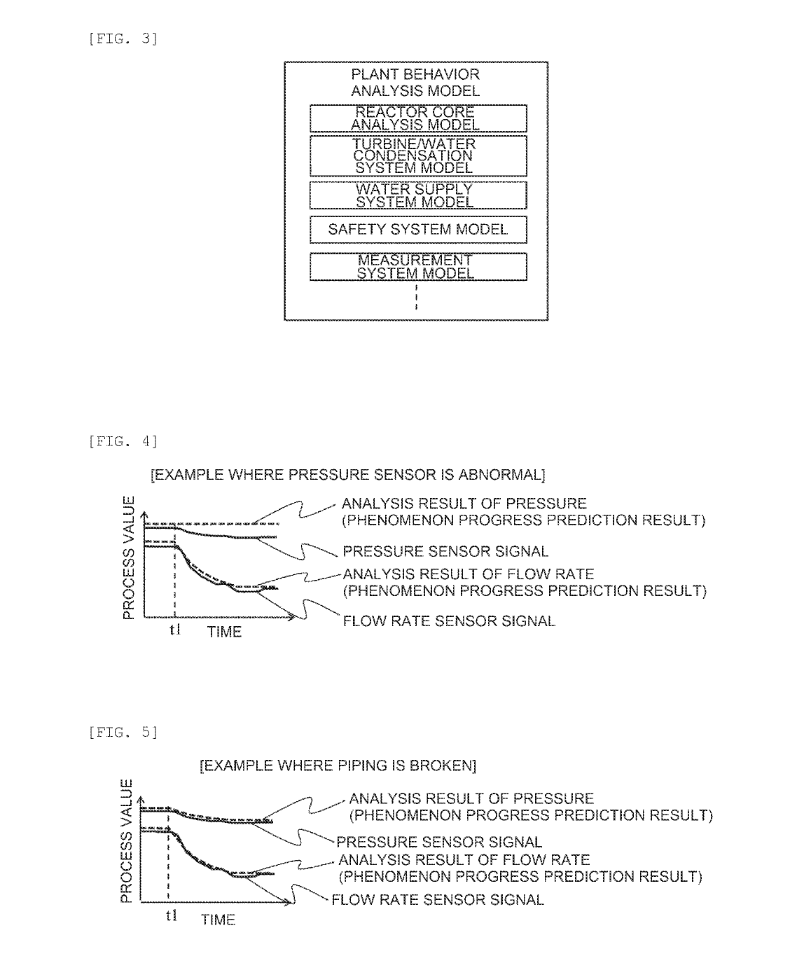

As shown in, for example, FIG. 2, the phenomenon identification apparatus 4 prepares in advance a table in which accident phenomena and respective device signals are associated with each other and determines that an accident phenomenon occurs when all conditions of the device signals are satisfied. Note that all the conditions in FIG. 2 indicate alarms. In this example, in the case where an alarm “reduction in flow rate A” is issued, an alarm “reduction in pressure A” is issued, an alarm “high radioactivity” is issued, and an alarm “high ambient temperature” is issued, it is determined that an accident phenomenon “breakage of main steam pipe A” occurs. A phenomenon identification result that is an output signal from the phenomenon identification apparatus 4 is output to the plant behavior analysis apparatus 3.

The plant behavior analysis apparatus 3 can predict progress of a process state by setting the input phenomenon identification result as an initial condition of plant behavior analysis, receiving the sensor signal 1aa indicating a state of the plant at that time and the device state signal/alarm signal 1b, and analyzing behavior of the plant after an occurring phenomenon (accident phenomenon) is identified in the phenomenon identification apparatus 4.

As shown in FIG. 3, for example, a model for analyzing behavior of the plant includes a reactor core analysis model (nuclear dynamic characteristic model, fuel behavior analysis model, thermal hydraulic model), turbine/water condensation system model, water supply system model, safety system model (high-pressure reactor core cooling system model, low-pressure water injection system model, isolation cooling system model, residual heat removal system model, automatic depressurization system model), a measurement system model, and the like. In particular, the safety system model includes an automatic start condition of a device of a safety system, and, in the case where a sensor signal indicating a process state exceeds the automatic start condition, the safety system model starts at least a device model of the safety system and analyzes behavior of the plant. As a result, it is possible to predict progress of the process state including operation of the safety system at the time of an accident. By providing a result thereof to a plant operator or a plant manager, a phenomenon progress prediction result (progress prediction result of process state) 5 can be obtained as output from the plant behavior analysis apparatus 3. The phenomenon progress prediction result 5 is output to a comparison device 6 of a sensor normality determination apparatus 8.

The plant behavior analysis apparatus 3 analyzes the behavior of the plant at a higher speed than that of a real time and can therefore execute progress prediction of the process state after the above occurring phenomenon (accident phenomenon) in a short time. By providing a result of this progress prediction to a plant operator or a plant manager, it is possible to know what will happen in the plant if nothing is done. Therefore, it is possible to consider a countermeasure plan before an abnormal state progresses and implement dealing operation. This makes it possible to improve safety of the plant.

The phenomenon progress prediction result (progress prediction result of process state) 5 and the sensor signal 1aa indicating a state of the plant are compared in the comparison device 6 of the sensor normality determination apparatus 8. In the case where comparison results match each other within an allowable error range, a normality determination device 7 determines that the sensor is normal, whereas, in the case where the comparison results deviate from the allowable error range, the normality determination device 7 determines that the sensor is abnormal and outputs a determination result.

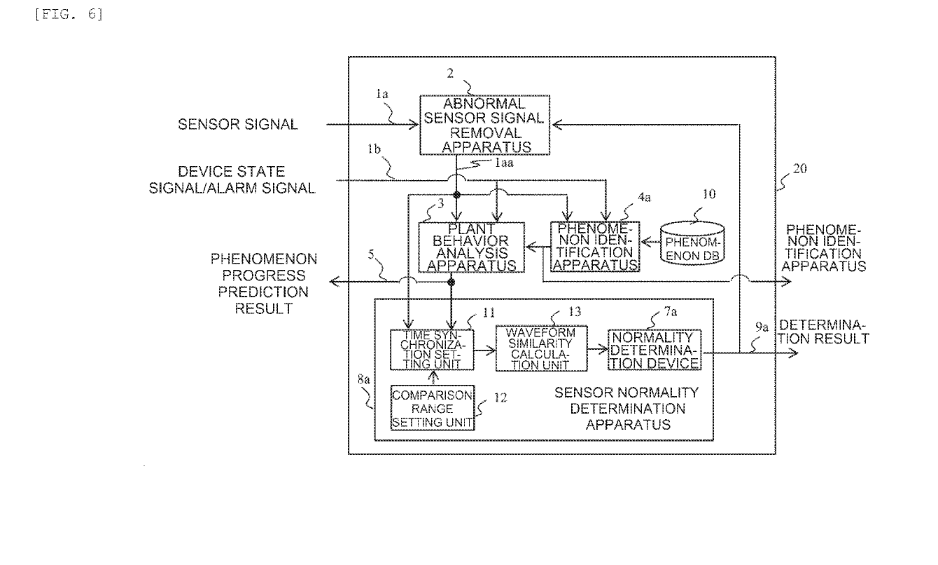

Determination examples of normality of the sensors are shown in FIG. 4 and FIG. 5. FIG. 4 is an example where a pressure sensor is abnormal. FIG. 4 shows a phenomenon in which certain operation is performed in a device at a time t1 and a flow rate is reduced in accordance with this operation. A solid line indicates a sensor signal, and a broken line indicates a phenomenon progress prediction result (progress prediction result of process state). The operation of the device is identified by the phenomenon identification apparatus 4. A result thereof is set as an initial condition of the plant behavior analysis apparatus 3, and, in the case where progress of the phenomenon thereafter is predicted, an analysis result of a pressure (progress prediction result of process state) is obtained as indicated by the broken line, i.e., the pressure is not changed. On the contrary, a pressure sensor signal is reduced from the time t1. Deviation between both the analysis result and the pressure sensor signal becomes large as time passes, and it is determined that the sensor is abnormal when the deviation deviates from the allowable error range. Regarding the flow rate, both a flow rate sensor signal and an analysis result of the flow rate (progress prediction result of process state) are similarly changed, i.e., comparison results of the flow rate sensor signal and the analysis result fall within the allowable error range, and therefore it is determined that a flow rate sensor is normal. That is, in this example, a result that the pressure sensor is abnormal is output.

FIG. 5 shows an example where piping is broken at the time t1. Breakage of the piping is identified by the phenomenon identification apparatus 4 in the same way as the breakage of the main steam pipe A described above. A result thereof is set as an initial condition of the plant behavior analysis apparatus 3, and, in the case where progress of the phenomenon thereafter is predicted in the plant behavior analysis apparatus 3, an analysis result of a pressure (progress prediction result of process state) indicates that the pressure is reduced from the time t1 as indicated by a broken line. A pressure sensor signal is also reduced from the time t1, and comparison results of the analysis result and the pressure sensor signal in the comparison device 6 fall within the allowable error range. Therefore, it is determined that the pressure sensor is normal. Also regarding a flow rate, both a flow rate sensor signal and an analysis result of the flow rate (progress prediction result of process state) are similarly changed, and the comparison results of the flow rate sensor signal and the analysis result fall within the allowable error range. Therefore, it is determined that the flow rate sensor is also normal. That is, this example indicates that, although both the pressure sensor and the flow rate sensor are normal, the flow rate and the pressure are reduced from the time t1. Therefore, it is possible to understand that this reduction is caused by a phenomenon of the breakage of the piping.

Note that a determination result is output from the sensor normality determination apparatus 8 to the abnormal sensor signal removal apparatus 2, and a sensor signal of a sensor that is determined to be abnormal is removed in the abnormal sensor signal removal apparatus 2, whereas the normal sensor signal 1aa is output from the abnormal sensor signal removal apparatus 2. That is, the plant does not behave in a state in which an abnormal sensor signal is included.

In this example, normality of a sensor can be determined by predicting progress of a process state after a phenomenon occurs with the use of at least a phenomenon identification result as an initial condition of plant behavior analysis and comparing a result of this prediction with a sensor signal. Therefore, it is possible to determine normality of the sensor on the basis of a state of the plant in which an accident occurrence state such as malfunction of a device is reflected.

Further, in this example, the state of the plant is identified by a logic with the use of at least a device state signal/alarm signal, and therefore phenomenon identification is not obscure. As a result, determination reliability of normality of the sensor is improved.

Furthermore, in this example, the plant behavior analysis apparatus includes the automatic start condition of the safety system and, in the case where a sensor signal indicating a process state exceeds the automatic start condition, the safety system model starts at least a device model of the safety system and analyzes behavior of the plant. Therefore, it is possible to predict a process state in which an operation status of the safety system that operates at the time of an accident is reflected. Accordingly, the determination reliability of the normality of the sensor is further improved.

### Example 2

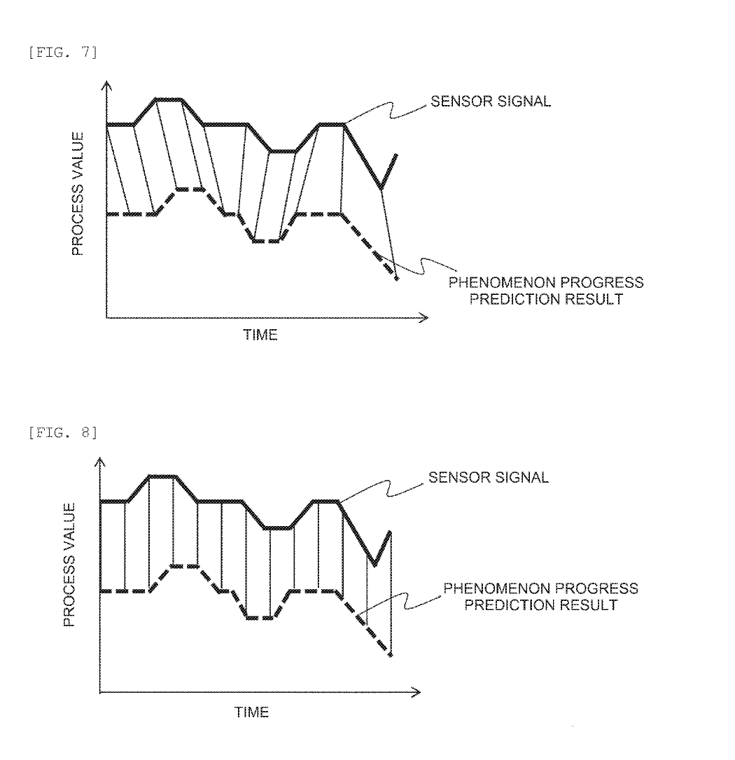

FIG. 6 shows a configuration example of a system for assisting operation at the time of a plant accident according to Embodiment 2. FIG. 6 is the same as FIG. 1 except for a configuration of a phenomenon identification apparatus 4a and a configuration of a sensor normality determination apparatus 8a.

10 indicates a large amount of a phenomenon database, in which change patterns of a plurality of processes (corresponding to sensor signals) and phenomena occurring in the plant are associated with each other. The large amount of the phenomenon database is prepared by causing various kinds of abnormality and device operation to occur with the use of, for example, a plant simulator in advance. In the case where the sensor signal 1aa and the device state signal/alarm signal 1b are input, the phenomenon identification apparatus 4a obtains similarity between those signals and data of the phenomenon database 10 and identifies an occurring phenomenon. A result thereof is output as an initial condition of plant behavior analysis. The large amount of the phenomenon database is constructed in advance as described above, and therefore, even in the case where, for example, combined phenomena occur, it is possible to accurately identify the phenomena, and it is possible to perform progress prediction of the plant on the basis of this identification. Note that, for example, DP (dynamic programming) matching can be used for calculating similarity, and a distance between each sensor signal and an analysis result (progress prediction result of process state) (a shift between both signals) is calculated regarding a plurality of process signals and a case of a lowest total amount among total amounts obtained as a result of calculation of those distances is identified as an occurring phenomenon.

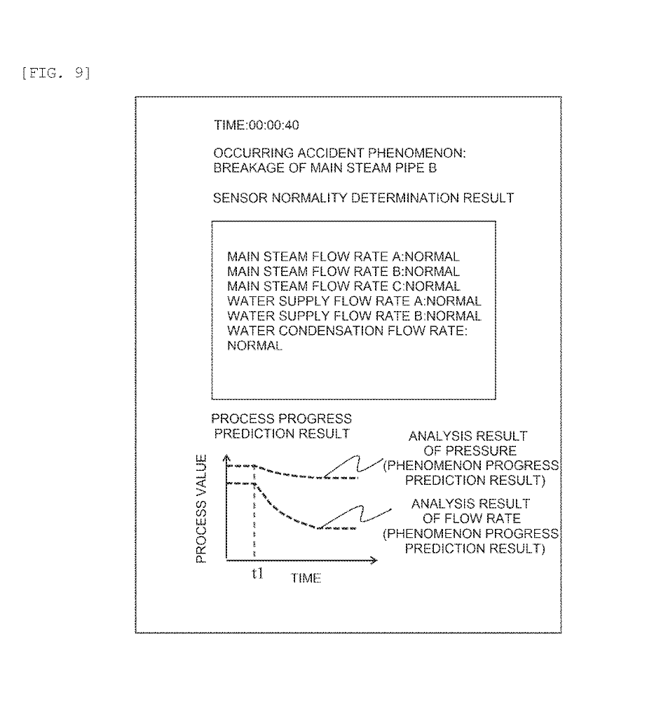

The sensor normality determination apparatus 8a includes a time synchronization setting unit 11, a comparison range setting unit 12, a waveform similarity calculation unit 13, and a normality determination device 7a. The time synchronization setting unit 11 and the comparison range setting unit 12 synchronize a time of a phenomenon progress prediction result that is an output signal from the plant behavior analysis apparatus 3 with a time of a sensor signal and compare the phenomenon progress prediction result with the sensor signal. There is no guarantee that the plant behavior analysis apparatus 3 executes calculation at the same speed as that of a real time. In the case where the time of the sensor signal and the time of the phenomenon progress prediction result are differently passed, the following are performed: a phenomenon identification result is output; synchronization is set to a time at which phenomenon progress prediction is started by the plant behavior analysis apparatus 3; start times of both signals that are different in terms of time as shown in FIG. 7 are synchronized as shown in FIG. 8 and a comparison range of both the signals is set in the comparison range setting unit 12. The normality of the sensor is determined by determining whether or not both the signals match each other on the basis of similarity in the waveform similarity calculation unit 13. It is determined that the sensor is normal in the case where the similarity falls within an allowable error range and the sensor is abnormal in the case where the similarity deviates from the allowable error range.

As described above, there is no guarantee that the plant behavior analysis apparatus 3 executes calculation at the same speed as that of a real time in the system 20 for assisting operation at the time of a plant accident in FIG. 1. In the case where a time of a sensor signal and a time of a phenomenon progress prediction result are differently passed, the times of the phenomenon progress prediction result that is an output signal from the plant behavior analysis apparatus 3 and the sensor signal are synchronized and the phenomenon progress prediction result and the sensor signal are compared as described above.

In this example, the normality of the sensor can be determined by predicting progress of a process state after a phenomenon occurs with the use of at least a phenomenon identification result as an initial condition of plant behavior analysis, synchronizing a time of a result of this prediction with a time of a sensor signal, and comparing the result with the sensor signal. Therefore, the result of the prediction of the progress of the process state after the phenomenon occurs can be compared with the sensor signal in a time shorter than a real time, and the normality of the sensor can be determined with respect to a plurality of phenomenon identification results.

Because similarity between a sensor signal and a device state signal/alarm signal and the phenomenon database is obtained to identify an occurring phenomenon and a process state of the plant that changes as time passes after the phenomenon occurs is predicted by using at least a result of this phenomenon identification as an initial condition of the plant behavior analysis, it is possible to identify a phenomenon that actually occurs from a plurality of phenomenon candidates. In addition, because the normality of the sensor is determined by synchronizing a time of a result of this prediction with a time of a sensor signal, comparing the result with the sensor signal, and evaluating similarity, it is possible to further improve the determination reliability of the normality of the sensor.

The systems 20 for assisting operation at the time of a plant accident in FIG. 1 and FIG. 6 display output results from the plant behavior analysis apparatus 3, the phenomenon identification apparatuses 4 and 4a, the sensor normality determination apparatuses 8 and 8a on a display apparatus or the like. FIG. 9 shows an example of an output screen. The screen displays an accident phenomenon that has occurred, normality determination results of the respective sensors, and process progress prediction results. Further, the system 20 for assisting operation at the time of a plant accident may be provided in a central control room and may display the results on a screen of a central control panel or a large display panel to provide a state of the accident of the plant as information to be shared by operators.

Note that the invention is not limited to the above examples and includes various modification examples. For example, the above examples have been described in detail to easily understand the invention, and therefore the invention is not necessarily limited to the examples having all the configurations described above. Further, configurations, functions, and the like described above can be realized by, for example, designing a part or all thereof with an integrated circuit. Furthermore, a processor may interpret programs realizing the respective functions and execute the programs to realize the configurations, the functions, and the like described above by software.

According to the invention, even if a device malfunctions at the time of a plant accident, normality of a sensor can be determined without being influenced by the malfunction. Thus, an industrial value thereof is extremely high.

### REFERENCE SIGNS LIST

1a sensor signal
1b device state signal/alarm signal
3 plant behavior analysis apparatus
4, 4a phenomenon identification apparatus
8, 8a sensor normality determination apparatus
20 system for assisting operation at the time of plant accident

1. A system for assisting operation at the time of a plant accident, comprising:
a phenomenon identification apparatus for identifying a state of a plant;
a plant behavior analysis apparatus for predicting progress of a process state after a phenomenon occurs by using at least a phenomenon identification result as an initial condition of plant behavior analysis; and
a sensor normality determination apparatus for determining normality of a sensor by comparing a result of prediction of the progress of the process state which is output from the plant behavior analysis apparatus with a sensor signal.

2. A system for assisting operation at the time of a plant accident, comprising:
a phenomenon identification apparatus for identifying a state of a plant;
a plant behavior analysis apparatus for predicting progress of a process state after a phenomenon occurs by using at least a phenomenon identification result as an initial condition of plant behavior analysis; and
a sensor normality determination apparatus for determining normality of a sensor by synchronizing a time of a result of prediction of the progress of the process state which is output from the plant behavior analysis apparatus with a time of a sensor signal and comparing the result with the sensor signal.

3. A system for assisting operation at the time of a plant accident, comprising:
a phenomenon identification apparatus for identifying an occurring phenomenon by obtaining similarity between a sensor signal and a device state signal/alarm signal and data of a phenomenon database;
a plant behavior analysis apparatus for predicting a process state of a plant that changes as time passes after a phenomenon occurs by using at least a phenomenon identification result as an initial condition of plant behavior analysis; and
a sensor normality determination apparatus for determining normality of a sensor by synchronizing a time of a result of prediction of the process state after the phenomenon occurs with a time of the sensor signal, comparing the result with the sensor signal, and evaluating the similarity.

4. A system for assisting operation at the time of a plant accident, wherein
the phenomenon identification apparatus according to claim 1 identifies a state of a plant by using at least a device state signal/alarm signal.

5. A system for assisting operation at the time of a plant accident, wherein
the plant behavior analysis apparatus according to claim 1 includes an automatic start condition of a device of a safety system and has a function of starting at least a device model of the safety system and analyzing behavior of a plant in the case where a sensor signal indicating a process state exceeds the automatic start condition.

6. A method for assisting operation at the time of a plant accident, comprising:
identifying a state of a plant;
predicting progress of a process state after a phenomenon occurs by using at least a phenomenon identification result as an initial condition of plant behavior analysis; and
predicting the progress of the process state which is output from a plant behavior analysis apparatus.
